(19) United States
(12) Patent Application Publication
(10) Pub. No.: US 2008/0201535 A1
(43) Pub. Date: Aug. 21, 2008

(54) Method and Apparatus for Provisioning Storage Volumes

(75) Inventor: Junichi Hara, San Jose, CA (US)

Correspondence Address: SUGHRUE MION, PLLC, 2100 Pennsylvania Avenue, N.W., Washington, DC, 20037, US

(73) Assignee: Hitachi, Ltd., Tokyo (JP)

(21) Appl. No.: 11/677,528

(22) Filed: Feb. 21, 2007

(51) Int. Cl. G06F 12/00

(52) U.S. Cl. 711/153

(57) ABSTRACT

A method for determining volume size in a storage system, comprising the steps of receiving a request for a volume assignment from a client host; obtaining client host specification; obtaining storage system specification; based on the client host specification and storage system specification selecting a proper volume size; and assigning a virtual volume to the client host, the virtual volume having the selected proper volume size.

### BACKGROUND

1. Field of the Invention

The subject invention relates to storage systems, storage area network (SAN), and their management software, in particular to provisioning of storage volumes to client hosts.

2. Related Art

In conventional storage systems, each storage volume has a preset capacity defining the limit of space for data storage. When a volume is assigned to a client host, its capacity needs to be determined based on the user's request, administrator's know-how, utilization ratio of physical resources in the whole storage system, such as disk drives, and so on. Also, after the volume is assigned, the utilization ratio of each volume needs to be monitored so that the client host using the volume will not run out of space to store data. In case that the utilization ratio of a certain volume is close to full, the administrator needs to take certain measures to avoid deleterious effects to the client host by, for example, expanding the volume, assigning another volume, etc. Therefore, the administrator of the storage system or the client host have a certain amount of operational workload to manage the capacity of the volumes.

Recently, a storage system having a function called allocation-on-use or thin provisioning has emerged. The storage system having this function can allocate virtual volumes, which at first have none or a small portion of actual disk space to store data. When a client host issues a write I/O request to a portion of a virtual volume, and if there is no actual disk space allocated to the portion, the storage system allocates actual disk space to the portion, and stores the data in the request on the allocated actual disk space. Using this method, a virtual volume having larger capacity than available disk space can be assigned to the client host.

A problem exists in the prior art that when a virtual volume is assigned to a host, the administrator generally has to make a decision about the size of the virtual volume. However, the size of the virtual volume can affect the performance of the system and the future workload of the administrator in managing the system. Therefore, a solution is needed to enable proper assignment of size to the virtual volume.

### SUMMARY

The following summary of the invention is provided in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Various aspects of the subject invention provide method and apparatus to eliminate the operational workload required for managing capacity and utilization ratio of volumes by automatically allocating virtual volumes which have capacity determined based upon preset criteria, such as the specification of the host system components, performance, or other requirements.

According to various aspects of the subject invention, the system comprises one or more storage systems having a feature of allocation-on-use or thin provisioning, management host, and one or more client hosts. When a user requests the management host to assign a volume to a client host, the management host automatically determines the virtual volume's capacity based upon predetermined criteria. Then, the management host assigns the virtual volume to the client host. The predetermined criteria can be defined based on specifications of the storage system and the client host, required performance specified in the request from the user, etc.

A method for determining volume size in a storage system is disclosed, comprising: receiving a request for a volume assignment from a client host; obtaining client host specification; obtaining storage system specification; based on the client host specification and storage system specification selecting a proper volume size; assigning a virtual volume to the client host, the virtual volume having the selected proper volume size. The method may further comprise obtaining user defined size and selecting the proper volume size also based on the user defined size. The user defined size may override selection made based on client host specification and storage system specification. The client host specification and storage system specification may override selection made based on user defined size. The method may further comprise obtaining performance requirements and selecting the proper volume size also based on the performance requirements. The performance requirements may override selection made based on client host specification and storage system specification. The method may further comprise obtaining maximum possible size of a virtual volume and selecting the proper volume size also based on the maximum possible size. The maximum possible size may override selection made based on client host specification and storage system specification.

A storage management apparatus is disclosed, comprising: an input for receiving volume assignment requests, storage system specifications, and client host specifications; a volume size policy reference indicating maximum allowable volume size corresponding to various combinations of storage system specifications and client host specifications; a storage system output for issuing export volume requests to the storage system; and a client host output for issuing mount volume requests to the client host. The policy reference may comprise a policy table having entries for platform, operating system, file system, and maximum assignable size. The policy table may further comprise entries for user defined size. The policy table may further comprise entries for performance requirements. The storage management apparatus may further comprise at least one performance table and wherein the entries for performance requirements comprise pointers to at least one performance table. The performance table may comprise entries for maximum throughput, maximum input/output operations per second, and maximum size.

A processor configured for determining volume size in a storage system is disclosed, the processor operable to perform the steps comprising: receiving a request for a volume assignment from a client host; obtaining client host specification; obtaining storage system specification; based on the client host specification and storage system specification selecting a proper volume size; assigning a virtual volume to the client host, the virtual volume having the selected proper volume size. The processor may be further configured to perform the step of selecting a proper volume size by referring to a volume sizing policy. The processor may be further configured to perform the step of referring to a volume sizing policy by selecting a volume size from a policy table. The processor may be further configured to perform the step of referring to a volume sizing policy by further referring to a performance table. The processor may be further configured to perform the step of selecting a volume size from the performance table and overriding a size indicated by the policy table. The processor may be further configured to perform the step of selecting a volume size from a user input and overriding a size indicated by the policy table.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 illustrates a storage system according to an embodiment of the invention.

FIG. 2 illustrates software module configuration according to an embodiment of the invention.

FIG. 3 illustrates a conceptual diagram of a logical device according to an embodiment of the invention.

FIG. 4 depicts an example of a RAID configuration table according to an embodiment of the invention.

FIG. 5 shows an example of configuration of a virtual device according to an embodiment of the invention.

FIG. 6 shows a virtual device configuration table according to an embodiment of the invention.

FIG. 7 shows an example of free logical device list (free LDEV list) according to an embodiment of the invention.

FIG. 8 shows an example of the device size policy table according to an embodiment of the invention.

FIG. 9 shows a process flow for allocating a volume, according to an embodiment of the invention.

FIG. 10 shows an example of the detailed process flow that is performed in step 903 by the provisioning manager on the management host to determine size of a volume to be allocated.

FIG. 11 shows an example of a performance table according to an embodiment of the invention.

FIG. 12 shows an alternative process flow including steps to confirm that user defined size is smaller than the maximum allowable size for the host and storage specifications.

FIG. 13 illustrates an example of a system according to another embodiment of the invention.

### DETAILED DESCRIPTION

Various embodiments of the invention will now be described in detail, illustrating the inventive methods and apparatus used to properly select the proper size for a virtual volume. As can be understood, various features of the invention may be implemented by a conventional computing machine programmed to perform specific tasks according to embodiments of the invention.

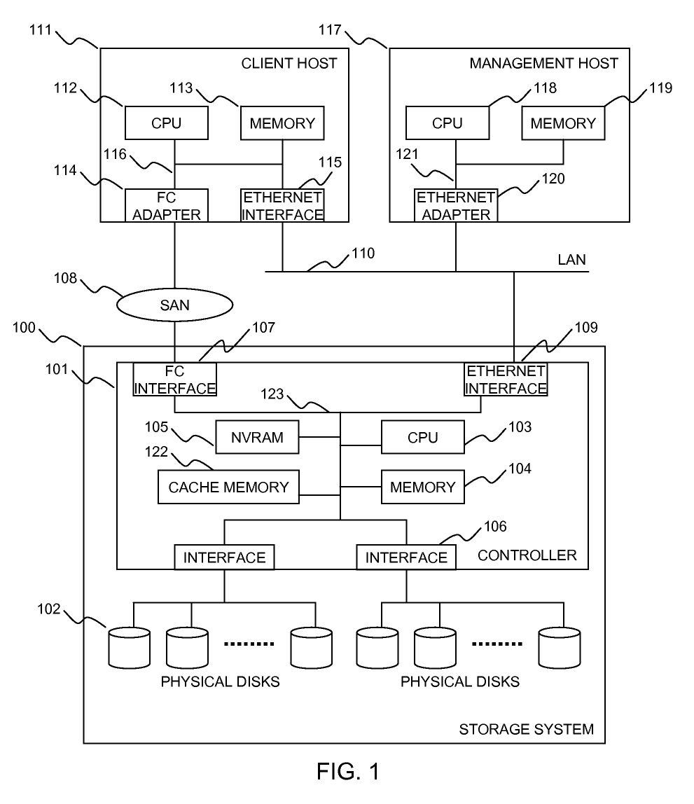

FIG. 1 illustrates a storage system according to an embodiment of the invention. As shown in FIG. 1, at least one client host 111 exists in the system. Each client host 111 comprises at least a CPU 112, memory 113, FC (Fibre Channel) adapter 114, and Ethernet adapter 115. These components are connected each other via internal bus 116. Each client host 111 is connected to the storage system 100 through the FC adapter 114 via SAN 108, and to the management host 117 through the Ethernet adapter 115 via LAN 110. Some of the programs realizing the invention according to this embodiment run on the client host 111 using CPU 112, but the structure of the host 111, the management host 117 and their interconnection may be implemented using conventional means.

The management host 117 comprises at least a CPU 118, memory 119, and Ethernet adapter 120. These components are connected to each other via internal bus 121. The management host 117 is connected to the client host 111, and the storage system 100 through the Ethernet adapter 120 via LAN 110. Some of the programs realizing the invention according to this embodiment run on the management host 117 using CPU 118.

The storage system 100 comprises a controller 101 and physical disks 102. Controller 101 comprises CPU 103, memory 104, NVRAM 105, backend interfaces 106, at least one FC interface 107, at least one Ethernet adapter 109, and cache memory 122. The controller 101 is connected to the client host 111 through the FC interface 107 via SAN 108, to the management host 117 through Ethernet adapter 109 via LAN 110, and to the physical disks 102 through backend interfaces 106. The physical disks 102 are typically hard disk drives. However, other data storage media such as optical disks, or flash memory can be used as physical disks 102. Physical disks 102 are connected to the controller 101.

The SAN 108 is composed of switches and cables so as to be able to establish communication conforming to an FC-SW (Fibre Channel Switched Fabric) standard between the client host 111 and the storage system 100. In other embodiments, the SAN 108 may consist of Ethernet (IP-SAN).

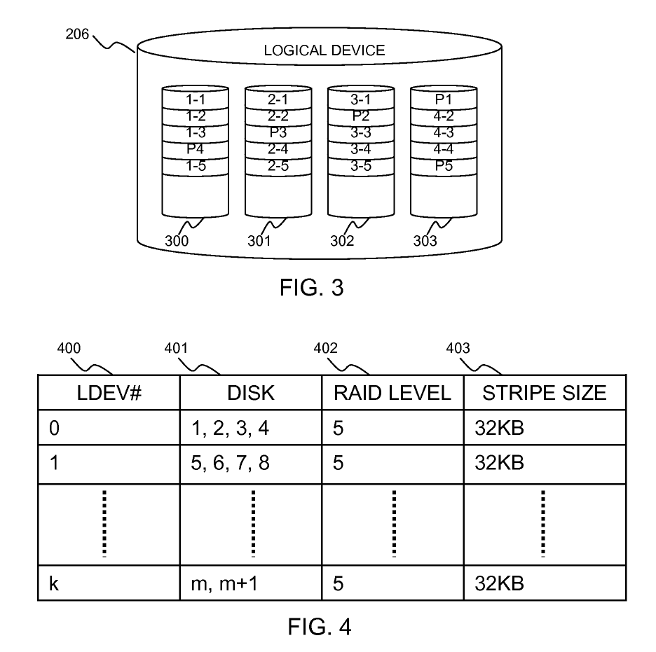

In the present embodiment, the controller 101 deals with three kinds of storage devices: physical devices, logical devices, and virtual devices. The physical device is the same as the physical disks 102. The controller 101 constructs at least one logical device using a plurality of physical devices. FIG. 3 illustrates a conceptual diagram of a logical device (LDEV). The logical device 206 illustrated in FIG. 3 is composed of four physical devices 300, 301, 302, and 303. Each region, labeled 1-1, 2-1, . . . , is called a stripe. A stripe is a predetermined length of disk block region in the RAID configuration table (FIG. 4). The region labeled P1, P2, . . . , is called parity stripe which is used for storing the parity data of the corresponding stripes. The controller 101 also constructs at least one virtual device using a portion of at least one logical device. From the perspective of the client host 111, only the virtual device is visible. Therefore, the client host 111 issues I/O requests towards the virtual devices.

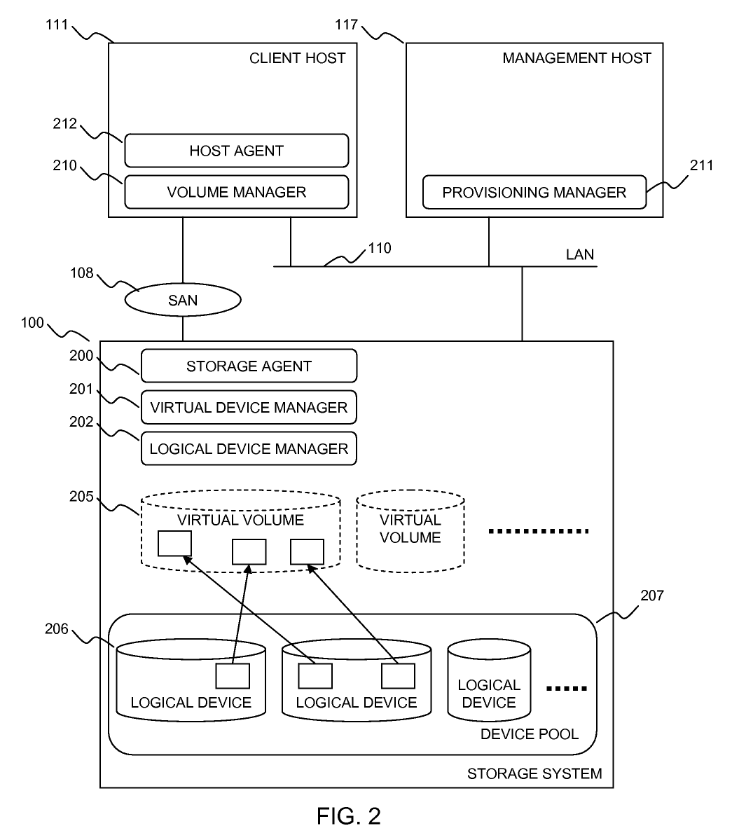

FIG. 2 illustrates software module configuration according to an embodiment of the invention. As shown in FIG. 2, there are three modules in the memory 104 in the controller 101: logical device manager 202, virtual device manager 201, and storage agent 200. The operation and features of these modules will now be described.

The logical device manager 202 creates one or more logical devices from physical disks 102, and manages the mapping between the logical devices and physical disks 102. FIG. 4 shows an example of a RAID configuration table that the logical device manager 202 uses to manage the mapping. In each row in the RAID configuration table, the information about each logical device is stored. Each logical device in the present embodiment has its own unique number, which is called logical device number (LDEV number), and which is stored in the table under the column LDEV#, indicated as element 400. Each physical disk 102 has its unique identification number (which is called disk number). In the column Disk 401, the disk numbers that construct the logical device are stored. In the present embodiment, the controller 101 constructs redundant arrays (RAID) from physical disks 102. The RAID level is stored in the column RAID level 402. The stripe size is stored under the column stripe size 403.

In the present embodiment, the RAID level, the number of disks constructing a RAID group, and the stripe size are of predetermined fixed value. Before using the storage system 100, users can set the above values. After these values are set, RAID groups and logical devices are automatically generated when users install physical disks 102. However, in other embodiments, users can set or change each value and each RAID level, the number of disks in each RAID group, and the stripe sizes may be defined in each RAID group.

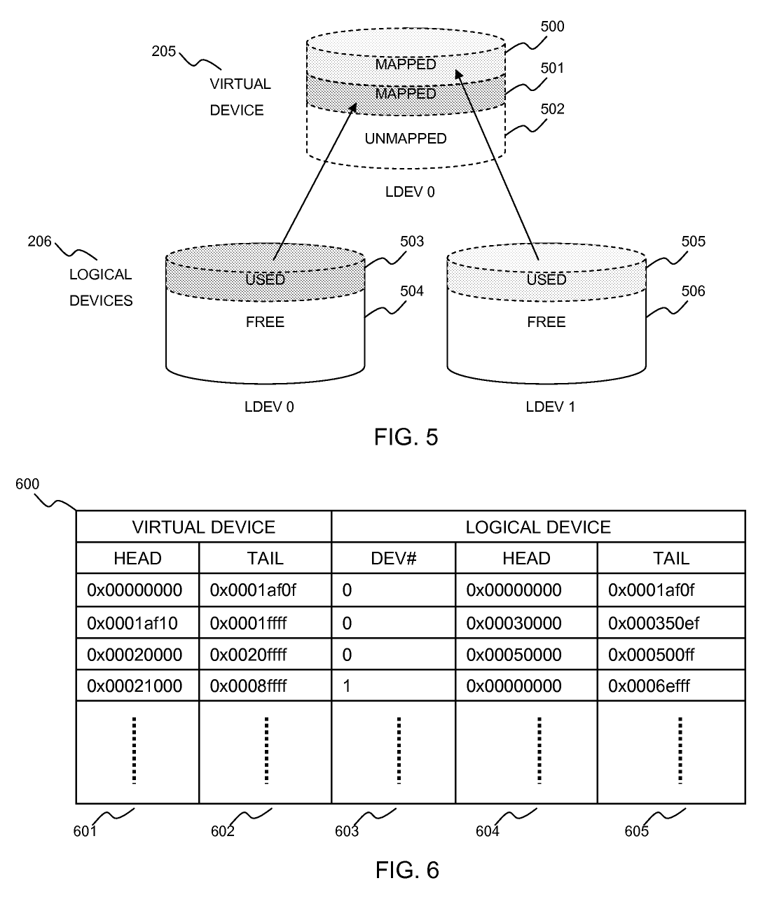

The virtual device manager 201 creates virtual devices from the logical devices 206, and manages the mapping between the regions in the logical devices, and the regions in the virtual devices. FIG. 5 shows an example of configuration of a virtual device 205. In the present embodiment, each region in the virtual device 205 is dynamically mapped to a region in the logical device 206. In the first state when a virtual device is created (i.e. before a write I/O request is received), no region in the logical device is mapped to the regions in the virtual devices 205. When the client host 111 issues a write I/O request to a region in the virtual device 205, the virtual device manager 201 assigns a free region of the logical devices 206 to the corresponding region in the virtual device 205 where the write I/O request is received.

FIG. 6 shows a virtual device configuration table 600 according to the present embodiment. The table exists for each virtual device 205. Each row has the elements HEAD 601, TAIL 602, DEV# 603, HEAD 604, and TAIL 605. The table manages the mapping of the virtual device 205 and logical devices 206. Each row means that the region in the virtual device 205 that is specified with HEAD 601 and TAIL 602 is mapped to the region in the logical device 206 that is specified with the combination of DEV# 603, HEAD 604, and TAIL 605. The corresponding logical block address (LBA) is stored for each element HEAD 601 and TAIL 602. The DEV# 603 shows the logical device number 400. The HEAD 604 and TAIL 605 are for storing the corresponding logical block address (LBA).

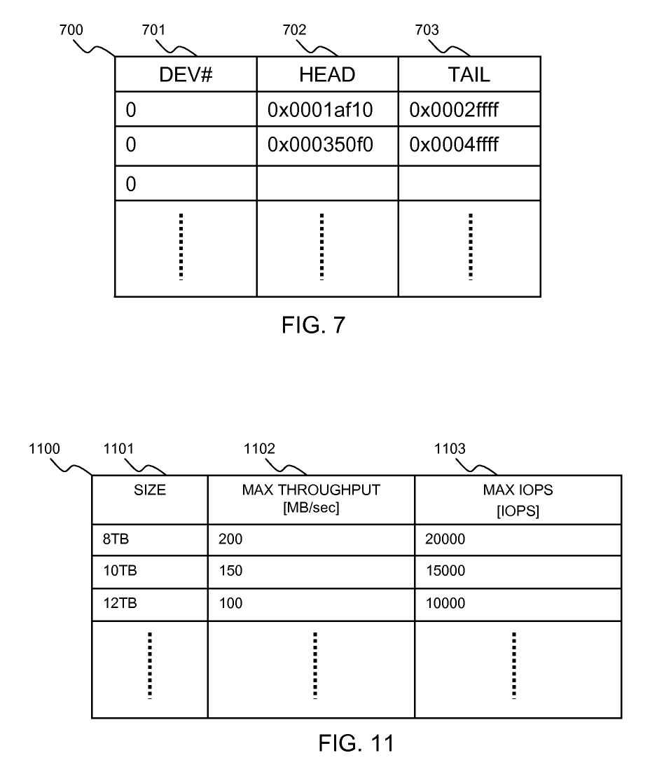

To assign the regions in the logical devices to the corresponding region in the virtual device 205 when I/O request comes from the client host 111, the virtual device manager 201 maintains the list of regions in the LDEV which is not mapped to any virtual devices 205. FIG. 7 shows an example of the free logical device list 700 (free LDEV list). The free local device list 700 includes a column for DEV# 701, which stores the logical device number 400; and columns for HEAD 702 and TAIL 703, the combination of which shows the regions of the logical device 206 which are not assigned to any virtual device 205.

The storage agent 200 returns the maximum possible size of a virtual device 205 to the management host 117. The maximum possible size is usually defined by vendor based on its hardware and software specification. However, according to embodiments of the invention, the size of an allocated virtual volume 205 is intelligently determined for each newly received volume request.

FIG. 2 also illustrates two kinds of modules in the memory 113 in the client host 111. The host agent 212 returns the specifications of hardware and software of the client host 111 in response to a request from the management host 117. Volume Manager 210 mounts and unmounts volumes exported by the storage system 100.

As also shown in FIG. 2, there is one module, provisioning manager 211, in the memory 119 in the management host 117. The provisioning manager 211 operates as follows. When receiving a request for a volume from a user or an administrator, it instructs the storage system 100 and the client host 111 to return its specifications. Also, it determines the volume size based on the request and the device size policy such as policy table 800. After determining the size, it instructs the storage system 100 to create and export a virtual volume 205, and instructs the client host 111 to mount the exported virtual volume.

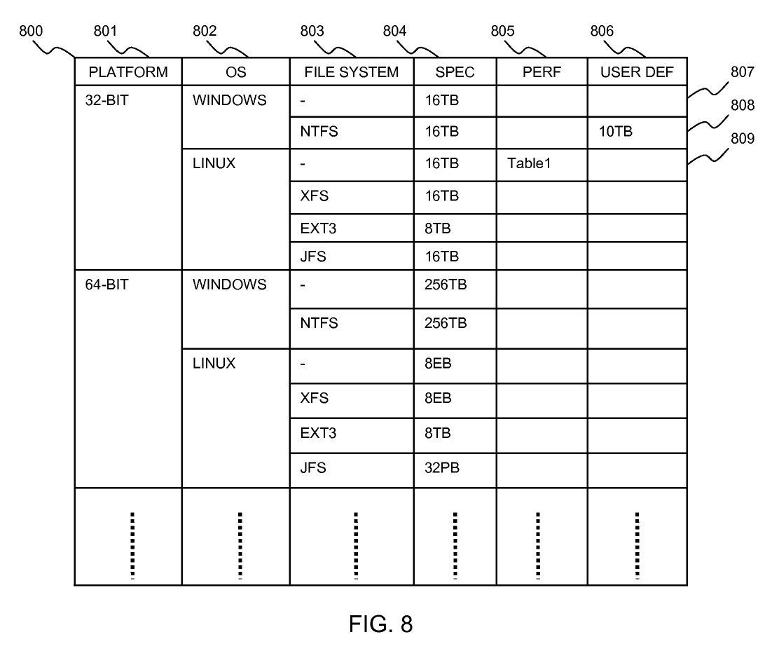

The provisioning manager 211 has a device size policy which can be implemented in the form of an algorithm, a function, a table etc. The device policy indicates the maximum allowable size of a volume depending on configuration and performance of host hardware and software, and user's intentions. FIG. 8 shows an example of a device size policy table 800. The device size policy table includes a Platform 801 column, which shows the hardware platform (Intel 32bit, Intel 64bit, etc) of the client host 111. The column OS 802 shows what kind of OS is running (or will run) on the client host 111. The column file system 803 shows what kind of file system the client host 111 will use the volume with. The column Spec 804 shows the maximum allowable size depending on specification of host hardware and software. The column Perf 805 includes pointers to other function or tables which indicate device size policy taking system performance into consideration. The User Def 806 column shows the user's definition of the maximum allowable size. It is used when a user wants to allocate a specific size for a certain configuration as an override to the system's allocation. This definition may be used in priority to all the other policies when size of a new volume is determined, so as to enable the override.

To provide a concrete example of the use of table 8, row 807 shows that the maximum allowable size of a volume of 32-bit Windows is 16 TB. It means that even if a volume that is larger than this size is assigned, the client host 111 can use only 16 TB of the volume, or it may be unable to mount the volume. Therefore, when assigning a volume for 32-bit Windows, the volume size cannot be larger than the indicated 16 TB. Conversely, row 808 shows that the maximum allowable size of a volume of NTFS on 32-bit Windows is 16 TB, but the administrator decided to allocate only 10 TB for this configuration. Therefore, 10 TB will be used for this configuration, since the user definition overrides the system allocation. Row 809 shows that there is a pointer to another table “Table1” in the Perf column 805. If the user specifies the minimum performance in the volume allocation request, the system would refer to “Table1” to determine the size of the new volume.

FIG. 11 shows an example of “Table1” 1100 according to an embodiment of the invention. In the embodiment of FIG. 11, the column Size 1101 indicates the size of a volume, while the columns MAX Throughput 1102 and MAX IOPS indicate maximum performance parameters for the size specified in the column “Size 1101”. In this example, the performance is stated in terms of throughput (MB/sec) or maximum I/O operations per second; however, other performance parameters may be used, such as, e.g., response time, etc.

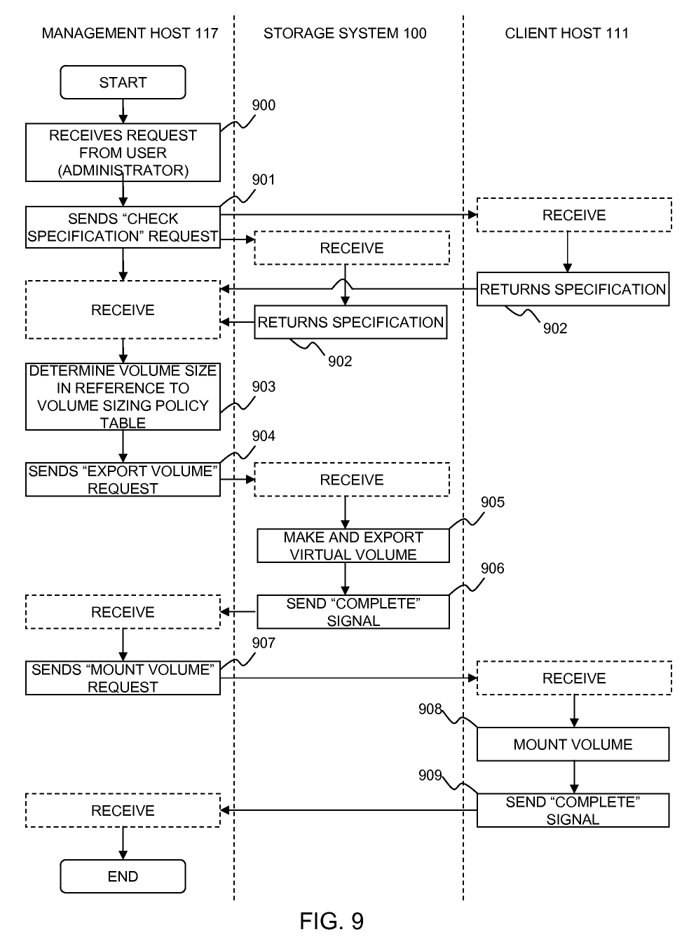

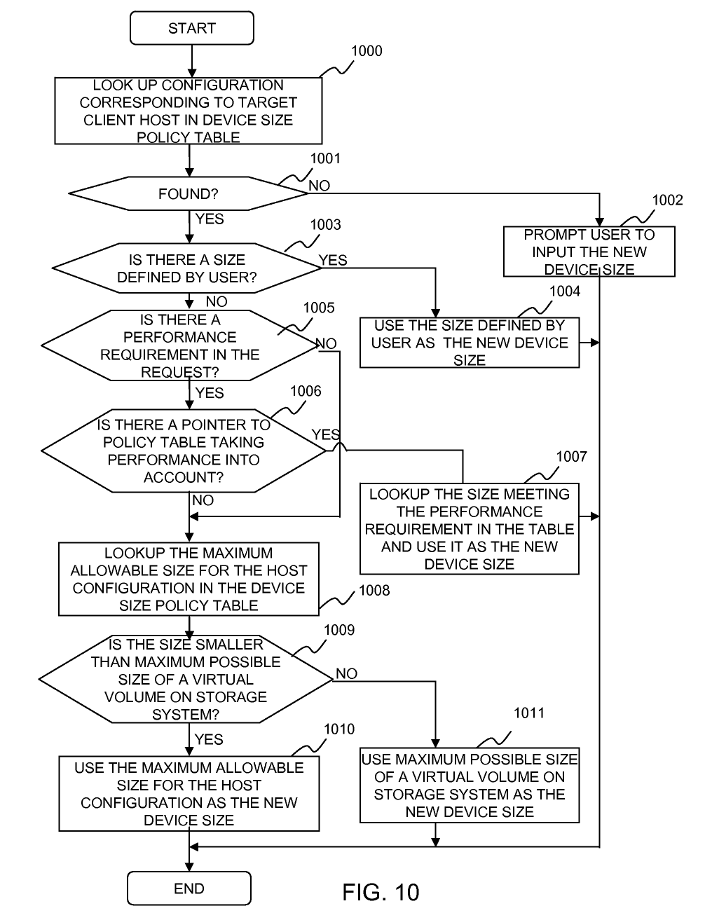

FIG. 9 shows a process flow for allocating a volume, according to an embodiment of the invention. This process is initiated when a user or an administrator requests the management host 117 to assign a volume to the client host 111. In Step 900 the provisioning manager 211 on the management host 117 receives a request to assign a volume. The request may be initiated by a user or an administrator of the management host 117. In some cases, the request includes intended purposes of the volume such as what file system will be used, minimum performance requirements, etc. At Step 901 the provisioning manager 211 on the management host 117 instructs the storage agent 200 on the storage system 100 and the host agent 212 on the client host 111 to return specifications of the storage system 100 and the client host 111. The specifications of the storage system 100 include a maximum possible size of a virtual device 205. The specifications of the client host 111 include types of hardware platform, OS (Windows, Linux, etc), etc. In Step 902 the storage agent 200 on the storage system 100 and the host agent 212 on the client host 111 return the specifications to the provisioning manager 200 on the management host 111. In Step 903 the provisioning manager 211 determines the size of the volume based on the user's request and the specifications of the storage system 100 and the client host 111. The detailed process flow is shown in FIG. 10 and described hereinafter. In Step 904 the provisioning manager 211 sends “export volume” request to the storage system 100. The request may include the parameters Port, LUN, and WWN. The Port parameter indicates the port through which the volume should be exported. The LUN (Logical Unit Number) parameter indicates the LUN that should be assigned to the new volume. The WWN of the host client 111 is an optional parameter; however, if the user wants to set an access control on the volume (make the volume inaccessible from other client hosts), this parameter is needed.

In response to the export volume request, in Step 905 the virtual device manager 201 makes a new virtual volume based on the parameters in the request from the provisioning manager 211, and exported it through the port specified in the request. In Step 906 the virtual device manager 201 returns a “complete” signal. In Step 907 the provisioning manager 211 sends “mount volume” request to the client host 111. The request may include the parameters LUN and WWN. The LUN parameter is the LUN of the new volume and the WWN parameter is the WWN of the port of the storage system through which the new volume is exported. Consequently, at step 908 the volume manager 210 mounts the new volume and in Step 909 the volume manager 210 returns a “completed” signal.

FIG. 10 shows an example of the detailed process flow that is performed in step 903 by the provisioning manager 211 on the management host 117 to determine the size of a volume to be allocated. In Step 1000 the provisioning manager 200 looks up a configuration corresponding to the target client host in the device size policy table 800. In Step 1001 the provisioning manager 200 checks if there is a column in the table corresponding to the configuration of the target client host. If a configuration corresponding to the target client host is found, it proceeds to step 1003. Otherwise, it proceeds to step 1002. Step 1002 the provisioning manager 211 prompts the user to input the size of the new device, sets the user input as the size of the new device, and ends the process. On the other hand, in Step 1003 the provisioning manager 211 checks if there is a size policy for the configuration defined by a user (i.e., if there is an entry in the USER DEF column 806). If there is a user entry, it proceeds to step 1004. Otherwise, it proceeds to step 1005.

In Step 1004 the provisioning manager 211 sets the size policy defined by user as the size of the new device, and ends the process. On the other hand, in Step 1005 the provisioning manager 211 checks if there is a performance requirement in the request from the user. If there is, it proceeds to step 1006. Otherwise, it proceeds to step 1008. In Step 1006 the provisioning manager 211 checks if there is a device size policy table taking performance into account (i.e., if there is a pointer entry in the PERF column 805). If there is, it proceeds to step 1007. Otherwise, it proceeds to step 1008. In Step 1007 the provisioning manager 211 looks up the maximum size that meets the performance requirement specified in the request from user, sets the size as the size of the new device, and ends the process. For example, if 150 MB/sec of throughput is required, the provisioning manager 211 set 10 TB as the size of the new device. In Step 1008 the provisioning manager 211 looks up the maximum allowable size for the host configuration (the SPEC column 804). In Step 1009 the provisioning manager 211 checks if the maximum allowable size for the host configuration is smaller than the maximum possible size of a virtual volume on the storage system 100. If it is, it proceeds to step 1010. Otherwise, it proceeds to step 1011. In Step 1010 the provisioning manager 211 sets the maximum allowable size for the host configuration as the size of the new device, and ends the process. In Step 1011 the provisioning manager 211 sets the maximum possible size of a virtual volume on the storage system 100 as the size of the new device, and ends the process.

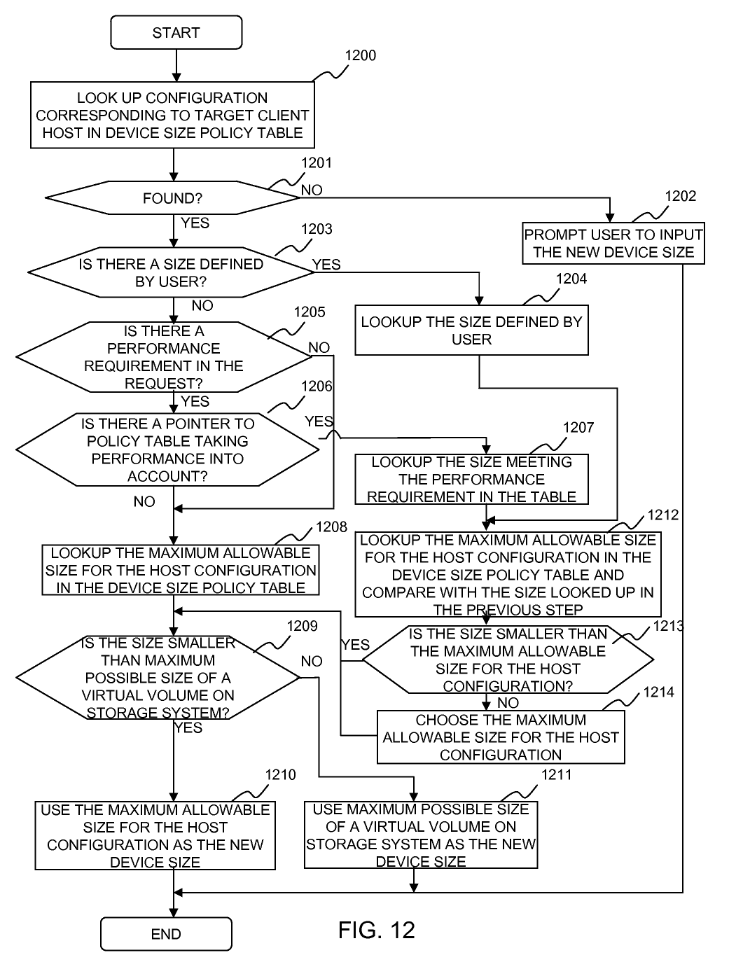

The process flow described in FIG. 9 uses the user defined size prior to any other criteria. However, the user defined size may exceed the maximum allowable size for the host and storage specifications. FIG. 12 illustrates an alternative process flow including steps to confirm that user defined size is smaller than the maximum allowable size for the host and storage specifications. In Step 1200 the provisioning manager 211 looks up a configuration corresponding to the target client host in the device size policy table 800. In Step 1201 the provisioning manager 211 checks if there is an entry in the policy table corresponding to the configuration of the target client host. If a configuration corresponding to the target client host is found, it proceeds to step 1203. Otherwise, it proceeds to step 1202. In Step 1202 the provisioning manager 211 prompts the user to input the size of the new device, sets the user input as the size of the new device, and ends the process.

On the other hand, in Step 1203 the provisioning manager 211 checks if there is an entry for size policy for the configuration defined by user (i.e., whether there is an entry in the USER DEF column 806). If there is, it proceeds to step 1204. Otherwise, it proceeds to step 1205. In Step 1204 the provisioning manager 211 looks up the size defined by the user, and proceeds to step 1212.

In Step 1205 the provisioning manager 211 checks if a performance requirement is specified in the request from the user. If there is, it proceeds to step 1206. Otherwise, it proceeds to step 1208. In Step 1206 the provisioning manager 211 checks if there is a pointer entry for a device size policy table (i.e., if there is a pointer in the PERF column 805). If there is, it proceeds to step 1207. Otherwise, it proceeds to step 1208. In Step 1207 the provisioning manager 211 looks up the maximum size that meets the performance requirement specified in the request from user. For example, if 150 MB/sec of throughput is required, the provisioning manager 211 set 10 TB as the size of the new device. The process then proceeds to Step 1212.

Meanwhile, in Step 1208 the provisioning manager 211 looks up the maximum allowable size for the host configuration (i.e., the SPEC column 804) and proceeds to Step 1209. In Step 1209 the provisioning manager 211 checks if the maximum allowable size for the host configuration is smaller than the maximum possible size of a virtual volume on the storage system 100. If it is, it proceeds to step 1210. Otherwise, it proceeds to step 1211. In Step 1210 the provisioning manager 211 sets the maximum allowable size for the host configuration as the size of the new device, and ends the process. On the other hand, in Step 1211 the provisioning manager 211 sets the maximum possible size of a virtual volume on the storage system 100 as the size of the new device, and ends the process.

Returning to Step 1212, the provisioning manager 211 looks up the maximum allowable size for the host configuration (the SPEC column 804), and compares it with the size looked up in the previous steps (step 1204 or 1207). In Step 1213 the provisioning manager 211 checks if the size looked up in the previous steps (step 1204 or 1207) is smaller than the maximum allowable size for the host configuration. If it is, it proceeds to step 1209. Otherwise, it proceeds to step 1214. In Step 1214 the provisioning manager 211 chooses the maximum allowable size for the host configuration and proceeds to Step 1209.

The process shown in FIG. 12 automatically uses the maximum allowable size for the host and storage configuration if the size defined by user exceeds it. On the other hand, the check can be made at the moment when the user defines the size, and an error message can be shown if the size the user inputs exceeds the maximum allowable size for the host configuration. That is, the system can prompt the user to specify a smaller size that is within the maximum allowable size for the host configuration.

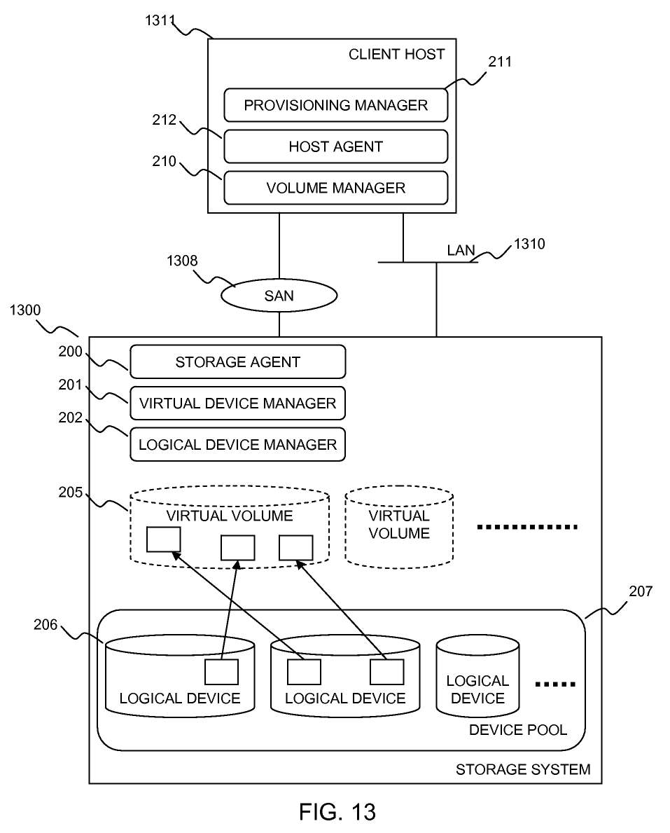

FIG. 13 illustrates an example of a system according to another embodiment of the invention. As shown in FIG. 13, according to this embodiment no management host is provided. Instead, the provisioning manager 211 is now provided on the client host 1311. This configuration is used for the applications that have the function of provisioning volumes. However, the same process flow discussed with respect to the first embodiment can be applied to this embodiment. The main difference is that the client host 1311 now also performs the role of the management host 117 detailed in the first embodiment. Therefore, the communication between the provisioning manager 211 and the host agent 212 is performed via IPC (Inter-Process Communication) within the client host 1311. Also the process flow of determining the size of a volume is the same process flow as illustrated for the first embodiment.

As can be understood, the subject invention enables assignment of the largest possible volume under the circumstances and parameters existing at the time of the initial assignment request. In this manner, the overhead associated with monitoring usage and assigning additional resources is eliminated. On the other hand, since the volume that is being assigned is a virtual volume, it does not use actual hardware resources until such are needed. Moreover, according to the invention the size of the volume is selected intelligently to enable proper operation under required configuration and performance requirements.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. Various aspects and/or components of the described embodiments may be used singly or in any combination in the plasma chamber arts. It is intended that the specification and examples be considered as exemplary only, with a true scope and spirit of the invention being indicated by the following claims.

1. A method for determining volume size in a storage system, comprising:
receiving a request for a volume assignment from a client host;
obtaining client host specification;
obtaining storage system specification;
based on the client host specification and storage system specification selecting a proper volume size;
assigning a virtual volume to the client host, the virtual volume having the selected proper volume size.

2. The method of claim 1, further comprising obtaining user defined size and selecting the proper volume size also based on the user defined size.

3. The method of claim 2, wherein the user defined size overrides selection made based on client host specification and storage system specification.

4. The method of claim 2, wherein the client host specification and storage system specification overrides selection made based on user defined size.

5. The method of claim 1, further comprising obtaining performance requirements and selecting the proper volume size also based on the performance requirements.

6. The method of claim 5, wherein the performance requirements overrides selection made based on client host specification and storage system specification.

7. The method of claim 1, further comprising obtaining maximum possible size of a virtual volume and selecting the proper volume size also based on the maximum possible size.

8. The method of claim 7, wherein the maximum possible size overrides selection made based on client host specification and storage system specification.

9. A storage management apparatus, comprising:
an input for receiving volume assignment requests, storage system specifications, and client host specifications;
a volume size policy reference indicating maximum allowable volume size corresponding to various combinations of storage system specifications and client host specifications;
a storage system output for issuing export volume requests to the storage system; and
a client host output for issuing mount volume requests to the client host.

10. The storage management apparatus of claim 9, wherein the policy reference comprises a policy table having entries for platform, operating system, file system, and maximum assignable size.

11. The storage management apparatus of claim 10, wherein the policy table further comprises entries for user defined size.

12. The storage management apparatus of claim 10, wherein the policy table further comprises entries for performance requirements.

13. The storage management apparatus of claim 12, further comprising at least one performance table and wherein the entries for performance requirements comprise pointers to at least one performance table.

14. The storage management apparatus of claim 13, wherein the performance table comprises entries for maximum throughput, maximum input/output operations per second, and maximum size.

15. A processor configured for determining volume size in a storage system and operable to perform the steps comprising:
receiving a request for a volume assignment from a client host;
obtaining client host specification;
obtaining storage system specification;
based on the client host specification and storage system specification selecting a proper volume size;
assigning a virtual volume to the client host, the virtual volume having the selected proper volume size.

16. The processor of claim 15 further configured to perform the step of selecting a proper volume size by referring to a volume sizing policy.

17. The processor of claim 16, further configured to perform the step of referring to a volume sizing policy by selecting a volume size from a policy table.

18. The processor of claim 17, further configured to perform the step of referring to a volume sizing policy by further referring to a performance table.

19. The processor of claim 18, further configured to perform the step of selecting a volume size from the performance table and overriding a size indicated by the policy table.

20. The processor of claim 18, further configured to perform the step of selecting a volume size from a user input and overriding a size indicated by the policy table.
